(19) United States
(12) Patent Application Publication
(10) Pub. No.: US 2025/0123975 A1
(43) Pub. Date: Apr. 17, 2025

(54) SYSTEMS AND METHODS FOR BUFFER MANAGEMENT DURING A DATABASE BACKUP

(71) Applicant: SAP SE, Walldorf (DE)

(72) Inventor: Dirk Thomsen, Heidelberg (DE)

(21) Appl. No.: 18/487,510

(22) Filed: Oct. 16, 2023

(51) Int. Cl. G06F 11/14; G06F 13/16

(52) U.S. Cl. CPC G06F 13/1673; G06F 2201/80

(57) ABSTRACT

Embodiments of the present disclosure include techniques for backing up data. In one embodiment, a single buffer memory is allocated. Data pages are read from a datastore and loaded into a first portion of the single buffer memory. When the first portion of the single buffer memory is full, data is from the datastore is loaded into a second portion of the single buffer memory while a plurality of jobs process data pages in parallel.

### BACKGROUND

The present disclosure relates generally to software systems, and in particular, to systems and methods for buffer management during a database backup.

Data is typically stored in a wide range of mediums on a computer system. As the computer performs operations, it may be desirable to move data from one medium to another. For example, data may be moved from a database into a random access memory (e.g., DRAM) during operation of the computer. When data is moved around a computer system, a buffer may be used to temporarily store the data.

One challenge with data movement and management in a computer system stems from the growing amount of data being stored by modern computer systems over time. While computer processing speeds have also increased over time, in some situations it has not kept up with the increase in the amount of data. Accordingly, processes for moving data between storage media on the computer system has started to take longer and longer over time in such situations.

The present disclosure addresses these and other challenges and is directed to techniques for buffer management.

### BRIEF DESCRIPTION OF THE DRAWINGS

FIG. 1 illustrates a system for buffer management during a data movement according to an embodiment.

FIG. 2 illustrates a method for buffer management during a data movement according to an embodiment.

FIG. 3 illustrates an example database backup system according to another embodiment.

FIG. 4 illustrates an example flow diagram for buffer management during a database backup according to another embodiment.

FIG. 5 illustrates hardware of a special purpose computing system configured according to the above disclosure.

### DETAILED DESCRIPTION

Described herein are techniques for buffer management during a data move. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

In some cases, when data is moved around a computer system a read operation retrieves data from one data storage location (e.g., a datastore) into a buffer and a write operation stores the data in another datastore. Data may be read into the buffer until the buffer is full. Then, data in the buffer is sent to a new destination. During read, data in the buffer cannot be sent to the new datastore. Accordingly, one technique to speed up data movement uses two buffers: one to read data into; and another previously filled buffer to send to the new datastore. While dual buffer data movement advantageously allows continuous data retrieval, using multiple buffers can cause problems where the buffers are in different parts of the computer system and operating at different speeds. Advantageously, some embodiments of the present disclosure include a data movement buffering technique that uses a single buffer memory. In some cases, data read into a buffer may be processed before the data is sent to the final destination. For double buffering, operations on the data may be suboptimal due to a hardware disparity between where the data is buffered and a particular processor (or central processing unit, CPU) doing the processing. By using a single buffer memory, speed of processing data in the buffer during movement may be optimized and data movements may be performed faster.

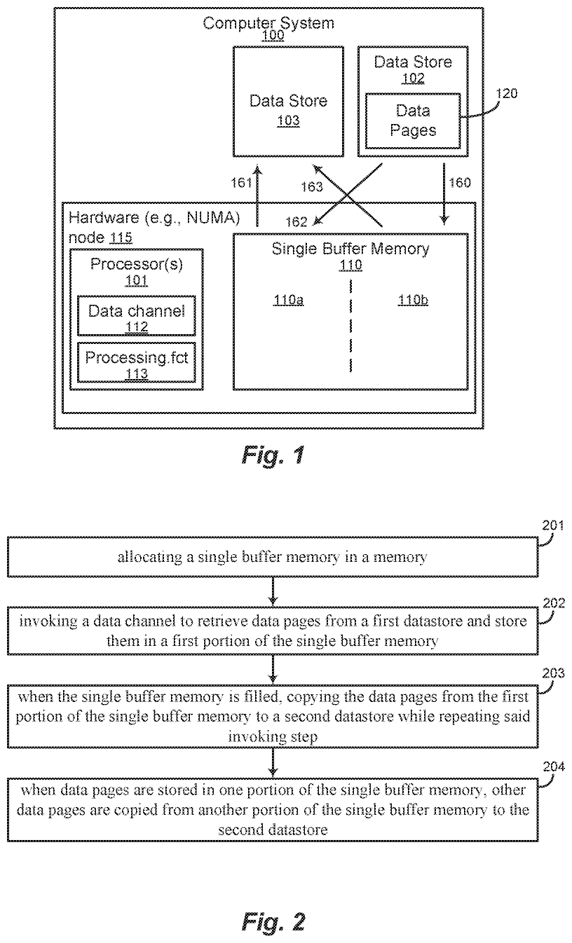

FIG. 1 illustrates a system for buffer management during a data movement according to an embodiment. Features and advantages of the present disclosure include techniques for moving data using buffer memory. FIG. 1 illustrates a computer system 100 comprising one or more processors 101, data storage media (data stores) 102 and 103, and a single buffer memory 110. Computer system 100 may comprise multiple computers, for example, coupled together over a computer interconnect mechanism (e.g., wired, such as Ethernet, or wireless, such as WiFi or cellular). Each computer may have one processor or multiple processors, for example. Buffer memory 110 may reside in any of a variety of memories, such as a dynamic random access memory (DRAM), for example. Data stores 102 and 103 may be memories on other parts of the system. In one embodiment, data store 102 is a persistent database and data store 103 is a backup storage medium, for example. It is to be understood that a wide variety of data storage mechanisms may benefit from, and be used with, the techniques described herein.

Data store 102 may contain data comprising data pages 120. A data page is a logical unit of data, typically many bytes. Examples of data pages include 4k, 16k, 64k, . . . , 4M, 16M data units. To move data pages 120 from data store 102 to data store 103, processor 101 may allocate single buffer memory 110 in a memory. The allocation may specify an address range set aside in memory for data to be stored in the buffer, for example. Processor 101 may execute a data channel software component (e.g., an object) to program the processor to perform the steps described herein. Features and advantages of the present disclosure include specifying different portions of buffer memory for use in (i) retrieving and processing data pages 120 and (ii) sending data pages 120 to data store 103. Buffer memory 110 may be divided into a portion 110a and a portion 110b. Data channel 112 may be invoked to retrieve data pages 120 from data store 102 and store data pages 120 in a portion 110b of buffer memory 110. When portion 110b of single buffer memory 110 is filled, data pages from portion 110b of single buffer memory 110 may be copied to data store 103 while repeating the step of invoking data channel 112 to retrieve data pages to portion 110a. When portion 110a is filled with data (and when portion 110b has finished moving data pages to data store 103), data pages from portion 110a may be loaded into data store 103 while portion 110b again receives data pages from data store 102. Accordingly, when data pages are stored in one portion of the single buffer memory 110, other data pages are copied from another portion of the single buffer memory 110 to data store 103. This is illustrated in FIG. 1, where data is retrieved from data store 102 and stored in buffer memory portion 110b at 160 while data is copied from buffer memory portion 110a to data store 103 at 161. At other times, data is retrieved from data store 102 and stored in buffer memory portion 110a at 162 while data is copied from buffer memory portion 110b to data store 103 at 163.

While modern multiprocessor or multicore computer systems offer advantages of speed and compute power, one challenge with such systems is that different portions of the system may run faster when working with some components than with others. In double buffer systems, data entering or leaving one buffer may traverse different hardware than data entering or leaving another buffer. Disparities in speed between the two buffers can create bottlenecks for systems, especially when processing is being performed on data in the buffer. For example, if multiple processing functions are executed on data in a buffer after it has been filled, but before it can be saved to the target destination, such processing functions may not be assigned to processors having the same underlying hardware and having the same memory access times. Features and advantages of some embodiments include, before data pages are copied from where they are stored in portions 110a or 110b of the single buffer memory, executing a plurality of processing functions on the data pages stored in the first or second portions 110a/b of the single memory buffer, where the plurality of processing functions 113 are executed on processors within a same hardware node 190 as the single buffer memory (e.g., where processors on the same hardware node have substantially similar memory access times that are faster than memory access times from processor not on the hardware node). Because one buffer is used, rather than multiple buffers, common hardware access speeds are achieved for processing functions assigned to processor(s) using the common hardware system.

In some embodiments, the single buffer memory 110 resides on a single non-uniform memory access (NUMA) node. Non-uniform memory access (NUMA) is a computer memory design used in multiprocessing, where the memory access time depends on the memory location relative to the processor. In a NUMA environment, a processor may have access to local memory and shared memory. However, a processor can access its own local memory faster than non-local memory (e.g., memory local to another processor or memory shared between processors). NUMA provides separate memory for each processor, avoiding the performance hit when several processors attempt to address the same memory. A NUMA node may comprise memory (e.g., DRAM), one or more processors, or memory and processors. In a computer hardware environment, hardware nodes may similarly comprise memory, one or more processors, or memory and processors. Accordingly, hardware nodes, such as NUMA nodes, may comprise multiple processors on a single motherboard, and all processors can access all the memory on the board. When a processor accesses memory that does not lie within its own node (remote memory), data must be transferred over the NUMA connection at a rate that is slower than it would be when accessing local memory. Thus, memory access times are not uniform and depend on the location (proximity) of the memory and the node from which it is accessed.

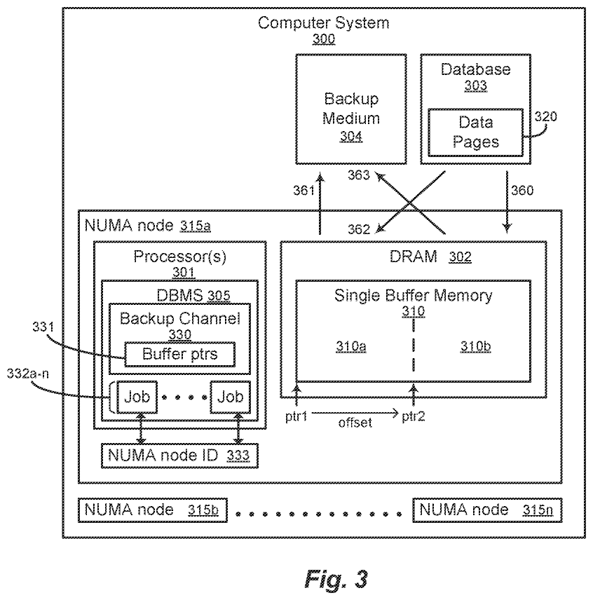

FIG. 2 illustrates a method for buffer management according to an embodiment. At 201, a single buffer memory is allocated in a memory, such as a DRAM, for example. At 202, a data channel is invoked to retrieve data pages from a first datastore and store the data pages in a first portion of the single buffer memory. At 203, when the first portion of the single buffer memory is filled, the data pages are copied from the first portion of the single buffer memory to a second datastore. While the data pages in the first portion of the buffer are copied, the invoking step is repeated, and data pages are retrieved and stored in a second portion of the buffer. At 204, the process continues such that when data pages are stored in one portion of the single buffer memory, other data pages are copied from another portion of the single buffer memory to the second datastore.

FIG. 3 illustrates an example database backup system according to another embodiment. Embodiments of the present disclosure may be advantageous for backing up databases. In this example, a computer system 300 includes a database 303 comprising a volume of data pages 320. It may be desirable to backup data pages 320 in a backup medium, such as a hard disk storage drive or other suitable backup memory system for storing large volumes of data. Computer system 300 may include a plurality of NUMA type hardware nodes 315a-n. A database management system (DBMS) 305 operating on one or more processors 301 may comprise a backup channel 330 software system for backing up data pages 320 in database 303. While the DBMS 305 is illustrated here operating on NUMA node 315a, it is to be understood that portions of the DBMS may operate on other NUMA nodes or an a different computer system, for example. Backup channel 330 may allocate single buffer memory 310 in DRAM 302. For example, backup channel 330 may execute code allocating a certain amount of memory and returning a first pointer (ptr1) associated with (e.g., pointing to) a beginning address of the single buffer memory. Backup channel 33 may then execute code creating a second pointer (ptr2) associated with an address offset from the first pointer. The following illustrates pseudo-code for allocating a 2 MB buffer and two pointers pointing to the top of the buffer and a midpoint in the buffer according to an example embodiment:

$$char * ptr 1 = allocate ( 2 * 1 GB ) ;$$

$$char * ptr 2 = ptr 1 + 1 GB .$$

In this example, the second buffer pointer, ptr2, is associated with an address offset from the first buffer pointer, ptr1, by half (e.g., 1 GB) the size of the single buffer memory (e.g., 2 GB).

Backup channel 330 may be invoked to retrieve data pages 320 from the database 303 and store the data pages in a first half of the single buffer memory. Initially, for example, data pages 320 may be stored in half 310b of buffer memory 310 at 360. When the first half 310b of the single buffer memory 310 is filled, the data pages are copied from the first half 310b of the single buffer memory to a backup computer readable storage medium 304 while repeating said invoking step such that retrieved data pages are stored in a second half 310a of the single buffer memory 310. Accordingly, when data pages are stored in one half of the single buffer memory, other data pages are copied from another half of the single buffer memory to the backup computer readable storage medium. Referring to pointers ptr1 and ptr2, when one pointer (ptr1 or ptr2) is used to retrieve data pages, the other pointer (ptr2 or ptr1) may be used to copy data pages to the backup medium 304.

In this example, before retrieved and stored data pages are copied from the first half or second half of the single buffer memory, processing functions may be executed on the data pages stored in the first half or second half of the single memory buffer. Advantageously, the processing functions are executed on processors on a same hardware node as the single buffer memory. For instance, in certain embodiments, when the first half 310b of buffer memory 310 is loading data pages, a plurality of jobs 332a-n may process the retrieved data pages. For example, jobs 332a-n may perform checksum error analysis on the data pages. A checksum is a small-sized block of data derived from another block of digital data for the purpose of detecting errors that may have been introduced during its transmission or storage as is known to those skilled in the art. Additionally, if the data pages are encrypted, jobs 332a-n may decrypt the data prior to performing checksum process, for example. Advantageously, the system may bind jobs 332a-n to NUMA node 315a so that the jobs are able to access single buffer memory 310, which is also on NUMA node 315a, at approximately the same speed. Jobs 332a-n may be assigned to separate threads. Binding the jobs to the same NUMA node results in all the job's threads to be executed on the same NUMA node, thus ensuring that some jobs are not assigned to threads on another NUMA node, which would result is slower access times when such jobs on other NUMA nodes attempt to access data in buffer memory 310. For example, a NUMA node identifier (ID) 333 associated with a particular NUMA node 315a where the single buffer memory 310 resides may be determined. In one embodiment, backup channel 331 may execute a get NUMA node identifier command (e.g., using a “getNUMANodeID” program call) and receive the NUMA node ID. For buffer memory on a single NUMA node, the get NUMA node ID command will return the NUMA node ID. However, if the get NUMA node ID command returns an invalid NUMA node ID, the invalid command indicates that the single buffer memory 310 resides on multiple NUMA nodes. If an invalid NUMANodeID is returned, indicating that the memory wasn't allocated on a single NUMA node, then the thread may not bind to a particular NUMA node. In some embodiments, the thread may be executed by the (linux) kernel on any node, for example. Once a valid NUMA node ID is obtained, program code may bind the jobs 332a-n operating on data in buffer 310 to the NUMA node ID. Binding the plurality of jobs 332a-n to the NUMA node ID 333 constrains jobs 332a-n to run exclusively on NUMA node 315a having the NUMA node ID 333. Jobs 332a-n may perform processing in the manner disclosed in commonly-owned, concurrently-filed U.S. patent application Ser. No. ______ (Attorney Docket Number 000005-104600US), entitled SYSTEMS AND METHODS FOR BACKING UP DATA, filed concurrently herewith, naming Dirk Thompsen as inventor, the entire disclosure of which is hereby incorporated herein by reference.

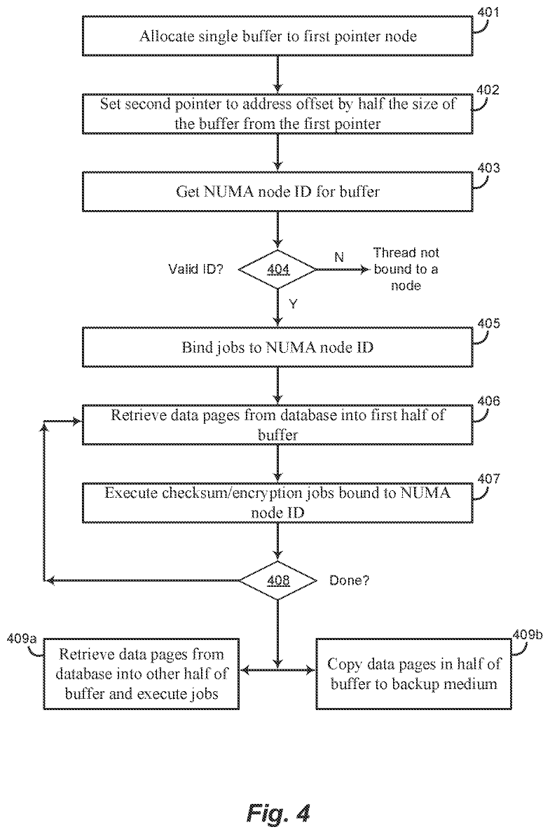

FIG. 4 illustrates an example flow diagram for buffer management during a database backup according to another embodiment. At 401 a single buffer is allocated to a first pointer. At 402, a second pointer is set to an address offset by half the size of the buffer from the first pointer. At 403, a NUMA node ID is determined for the buffer (e.g., using a getNUMANodeID command). At 404, the system determines if the NUMA node ID is valid. If not, then the thread may not be bound to a particular node. If the NUMA node ID is valid, jobs may be bound to the NUMA node ID at 405. At 406, data pages are retrieved from a database and stored in a first half of the buffer starting at the address of the first pointer. At 407, checksum (and decryption, if necessary) jobs bound to the NUMA node ID are executed. The jobs may be executed on a plurality of threads running on the NUMA node, for example. At 408, the system repeats steps 406 and 407 until done. At 409a, data pages are retrieved from the database and stored in the other half of the buffer and the jobs are executed. At 409b, in parallel with step 409a, data pages in half the buffer are copied to the backup medium.

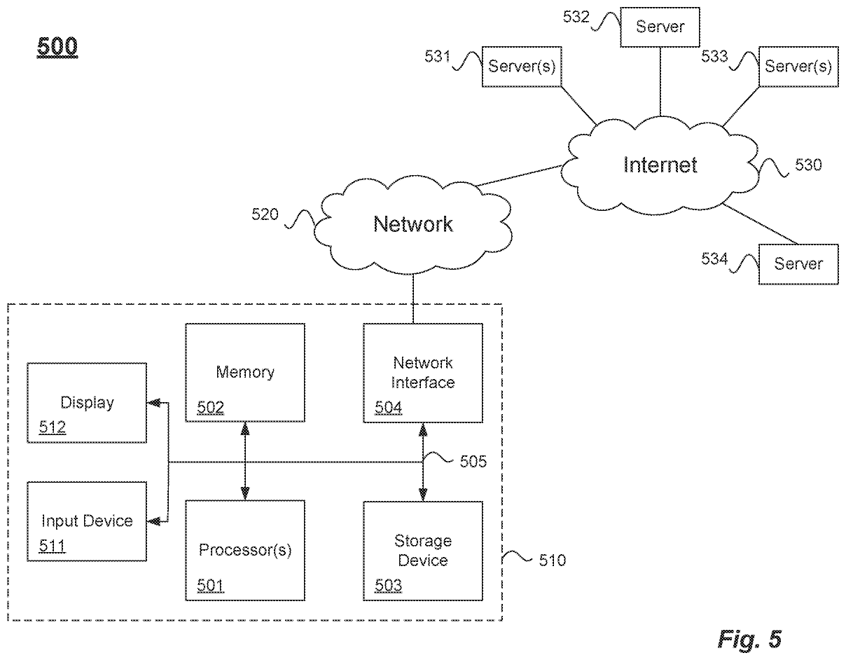

FIG. 5 illustrates hardware of a special purpose computing system 500 configured according to the above disclosure. The following hardware description is merely one example. It is to be understood that a variety of computers topologies may be used to implement the above-described techniques. An example computer system 510 is illustrated in FIG. 5. Computer system 510 includes a bus 505 or other communication mechanism for communicating information, and one or more processor(s) 501 coupled with bus 505 for processing information. Computer system 510 also includes memory 502 coupled to bus 505 for storing information and instructions to be executed by processor 501, including information and instructions for performing some of the techniques described above, for example. Memory 502 may also be used for storing programs executed by processor(s) 501. Possible implementations of memory 502 may be, but are not limited to, random access memory (RAM), read only memory (ROM), or both. A storage device 503 is also provided for storing information and instructions.

Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 503 may include source code, binary code, or software files for performing the techniques above, for example. Storage device 503 and memory 502 are both examples of non-transitory computer readable storage mediums (aka, storage media).

In some systems, computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses for coupling various components of the computer together, for example.

Computer system 510 also includes a network interface 504 coupled with bus 505. Network interface 504 may provide two-way data communication between computer system 510 and a local network 520. Network 520 may represent one or multiple networking technologies, such as Ethernet, local wireless networks (e.g., WiFi), or cellular networks, for example. The network interface 504 may be a wireless or wired connection, for example. Computer system 510 can send and receive information through the network interface 504 across a wired or wireless local area network, an Intranet, or a cellular network to the Internet 530, for example. In some embodiments, a frontend (e.g., a browser), for example, may access data and features on backend software systems that may reside on multiple different hardware servers on-prem 531 or across the network 530 (e.g., an Extranet or the Internet) on servers 532-534. One or more of servers 532-534 may also reside in a cloud computing environment, for example.

### Further Examples

Each of the following non-limiting features in the following examples may stand on its own or may be combined in various permutations or combinations with one or more of the other features in the examples below. In various embodiments, the present disclosure may be implemented as a system, method, or computer readable medium.

Embodiments of the present disclosure may include systems, methods, or computer readable media. In one embodiment, the present disclosure includes computer system comprising: at least one processor and at least one non-transitory computer readable medium (e.g., memory) storing computer executable instructions that, when executed by the at least one processor, cause the computer system to perform a method as described herein and in the following examples. In another embodiment, the present disclosure includes a non-transitory computer-readable medium storing computer-executable instructions that, when executed by at least one processor, perform a method as described herein and in the following examples.

In one embodiment, the present disclosure includes, in a database management system coupled to a database, a method of buffering data comprising: allocating a single buffer memory in a dynamic random access memory; invoking a backup channel to retrieve data pages from the database and store the data pages in a first half of the single buffer memory; and when the first half of the single buffer memory is filled, copying the data pages from the first half of the single buffer memory to a backup computer readable storage medium while repeating said invoking step, wherein retrieved data pages are stored in a second half of the single buffer memory, wherein when data pages are stored in one half of the single buffer memory, other data pages are copied from another half of the single buffer memory to the backup computer readable storage medium.

In one embodiment, the method further comprising, before data pages are copied from the first half or second half of the single buffer memory, executing a plurality of processing functions on the data pages stored in the first half or second half of the single memory buffer, wherein the plurality of processing functions are executed on processors on a same hardware node as the single buffer memory.

In one embodiment, the single buffer memory resides on a single non-uniform memory access (NUMA) node.

In one embodiment, allocating the single buffer memory comprises: associating a first buffer pointer with a beginning address of the single buffer memory; and associating a second buffer pointer with an address offset from the first buffer pointer, wherein when one of the first buffer pointer or the second buffer pointer are used to retrieve data pages, the other one of the first buffer pointer or the second buffer pointer are used to copy data pages to the backup computer readable storage medium.

In one embodiment, the second buffer pointer is associated with an address offset from the first buffer pointer by half the size of the single buffer memory.

In one embodiment, the method further comprising determining a non-uniform memory access (NUMA) node identifier associated with a particular NUMA node where the single buffer memory resides.

In one embodiment, determining a NUMA node identifier comprises executing a get NUMA node identifier command and receiving the NUMA node identifier, wherein an invalid command indicates that the single buffer memory resides on multiple NUMA nodes.

In one embodiment, the method further comprising binding a plurality of jobs to the NUMA node identifier, wherein the plurality of jobs processes the data pages in the single buffer memory, and wherein said binding the plurality of jobs to the NUMA node identifier constrains the plurality of jobs to run exclusively on a NUMA node having said NUMA node identifier.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. In a database management system coupled to a database, a method of buffering data comprising:
allocating a single buffer memory in a dynamic random access memory;
invoking a backup channel to retrieve data pages from the database and store the data pages in a first half of the single buffer memory; and
when the first half of the single buffer memory is filled, copying the data pages from the first half of the single buffer memory to a backup computer readable storage medium while repeating said invoking step, wherein retrieved data pages are stored in a second half of the single buffer memory,
wherein when data pages are stored in one half of the single buffer memory, other data pages are copied from another half of the single buffer memory to the backup computer readable storage medium.

2. The method of claim 1, further comprising, before data pages are copied from the first half or second half of the single buffer memory, executing a plurality of processing functions on the data pages stored in the first half or second half of the single memory buffer, wherein the plurality of processing functions are executed on processors on a same hardware node as the single buffer memory.

3. The method of claim 1, wherein the single buffer memory resides on a single non-uniform memory access (NUMA) node.

4. The method of claim 1, wherein allocating the single buffer memory comprises:
associating a first buffer pointer with a beginning address of the single buffer memory; and
associating a second buffer pointer with an address offset from the first buffer pointer,
wherein when one of the first buffer pointer or the second buffer pointer are used to retrieve data pages, the other one of the first buffer pointer or the second buffer pointer are used to copy data pages to the backup computer readable storage medium.

5. The method of claim 4, wherein the second buffer pointer is associated with an address offset from the first buffer pointer by half the size of the single buffer memory.

6. The method of claim 1, further comprising determining a non-uniform memory access (NUMA) node identifier associated with a particular NUMA node where the single buffer memory resides.

7. The method of claim 6, wherein determining a NUMA node identifier comprises executing a get NUMA node identifier command and receiving the NUMA node identifier, wherein an invalid command indicates that the single buffer memory resides on multiple NUMA nodes.

8. The method of claim 7, further comprising binding a plurality of jobs to the NUMA node identifier, wherein the plurality of jobs processes the data pages in the single buffer memory, and wherein said binding the plurality of jobs to the NUMA node identifier constrains the plurality of jobs to run exclusively on a NUMA node having said NUMA node identifier.

9. A computer system comprising:
at least one processor;
at least one non-transitory computer readable medium storing computer executable instructions that, when executed by the at least one processor, cause the computer system to perform a method of buffering data comprising:
allocating a single buffer memory;
invoking a data channel to retrieve data pages from a first datastore and store the data pages in a first portion of the single buffer memory; and
when the first portion of the single buffer memory is filled, copying the data pages from the first portion of the single buffer memory to a second datastore while repeating said invoking step, wherein retrieved data pages are stored in a second portion of the single buffer memory,
wherein when data pages are stored in one portion of the single buffer memory, other data pages are copied from another portion of the single buffer memory to the second datastore.

10. The computer system of claim 9, further comprising, before data pages are copied from the first or second portion of the single buffer memory, executing a plurality of processing functions on the data pages stored in the first or second portion of the single memory buffer, wherein the plurality of processing functions are executed on processors on a same hardware node as the single buffer memory.

11. The computer system of claim 9, wherein the single buffer memory resides on a single non-uniform memory access (NUMA) node.

12. The computer system of claim 9, wherein allocating the single buffer memory comprises:
associating a first buffer pointer with a beginning address of the single buffer memory; and
associating a second buffer pointer with an address offset from the first buffer pointer,
wherein when one of the first buffer pointer or the second buffer pointer are used to retrieve data pages, the other one of the first buffer pointer or the second buffer pointer are used to copy data pages to the second datastore.

13. The computer system of claim 12, wherein the second buffer pointer is associated with an address offset from the first buffer pointer by half the size of the single buffer memory.

14. The computer system of claim 9, further comprising determining a non-uniform memory access (NUMA) node identifier associated with a particular NUMA node where the single buffer memory resides.

15. The computer system of claim 14, wherein determining a NUMA node identifier comprises executing a get NUMA node identifier command and receiving the NUMA node identifier, wherein an invalid command indicates that the single buffer memory resides on multiple NUMA nodes.

16. The computer system of claim 15, further comprising binding a plurality of jobs to the NUMA node identifier, wherein the plurality of jobs processes the data pages in the single buffer memory, and wherein said binding the plurality of jobs to the NUMA node identifier constrains the plurality of jobs to run exclusively on a NUMA node having said NUMA node identifier.

17. A non-transitory computer-readable medium storing computer-executable instructions that, when executed by at least one processor, perform a method of buffering data, the method comprising:
allocating a single buffer memory;
invoking a data channel to retrieve data pages from a first datastore and store the data pages in a first portion of the single buffer memory; and
when the first portion of the single buffer memory is filled, copying the data pages from the first portion of the single buffer memory to a second datastore while repeating said invoking step, wherein retrieved data pages are stored in a second portion of the single buffer memory,
wherein when data pages are stored in one portion of the single buffer memory, other data pages are copied from another portion of the single buffer memory to the second datastore.

18. The non-transitory computer-readable medium of claim 17, wherein
allocating the single buffer memory comprises:
associating a first buffer pointer with a beginning address of the single buffer memory; and
associating a second buffer pointer with an address offset from the first buffer pointer,
wherein when one of the first buffer pointer or the second buffer pointer are used to retrieve data pages, the other one of the first buffer pointer or the second buffer pointer are used to copy data pages to the second datastore, and wherein the second buffer pointer is associated with an address offset from the first buffer pointer by half the size of the single buffer memory.

19. The non-transitory computer-readable medium of claim 17, further comprising determining a non-uniform memory access (NUMA) node identifier associated with a particular NUMA node where the single buffer memory resides.

20. The non-transitory computer-readable medium of claim 19, wherein determining a NUMA node identifier comprises executing a get NUMA node identifier command and receiving the NUMA node identifier, wherein an invalid command indicates that the single buffer memory resides on multiple NUMA nodes, and further comprising binding a plurality of jobs to the NUMA node identifier, wherein the plurality of jobs processes the data pages in the single buffer memory, and wherein said binding the plurality of jobs to the NUMA node identifier constrains the plurality of jobs to run exclusively on a NUMA node having said NUMA node identifier.
